(19) United States
(12) Patent Application Publication
(10) Pub. No.: US 2025/0128799 A1
(43) Pub. Date: Apr. 24, 2025

(54) LIFE PRESERVER

(71) Applicant: RFD Beaufort Limited, Ellesmere Port (GB)

(72) Inventor: Paul OLIVER, Rhyl, Denbighsire (GB)

(21) Appl. No.: 18/834,998

(22) PCT Filed: Feb. 2, 2023
(86) PCT No.: PCT/EP2023/052553

§ 371 Date: Jul. 31, 2024

(30) Foreign Application Priority Data
Feb. 3, 2022 (GB) 2201373.4

(51) Int. Cl. B63C 9/125; A41D 13/012; A41D 13/018; A62B 17/00

(52) U.S. Cl. CPC B63C 9/1255; A41D 13/012; A41D 13/018; A62B 17/003; A62B 17/008

(57) ABSTRACT

A personal protection garment (110) configured to cover at least a part of a wearer's body in use, wherein the protection garment includes an inflatable chamber in region (119) configured to provide buoyancy to support the wearer's body on water when inflated to protect the wearer from drowning.

### TECHNICAL FIELD

The present invention relates to a personal protection garment. The present invention also relates to a method of protecting a person from drowning.

### BACKGROUND TO THE INVENTION

Aircrew members such as pilots wear an ensemble including a protective flight garment (e.g., a flight suit or vest) when flying in aircraft. Traditionally the suit is either a single piece suit combining both jacket and trousers in a single garment or it is a two-piece suit with a separate jacket and trousers.

The protective garment may include special equipment (Aircrew Life Support Equipment—ALSE) that protects the wearer against the effects of high G-acceleration or altitude and other potentially damaging factors.

When flying their aircraft over water, the pilot and crew typically have a life preserver unit (e.g. a lifejacket) which is usually attached to and worn over the protective flight garment, the ensemble comprising the protective flight garment and life preserver unit.

Traditional designs of life preservers that are worn around the wearer's neck can cause bulk and restriction to head movement and in aviation applications they can cause interaction with the aircrew helmets, further reducing head mobility and causing displacement of the helmet. In addition, the prominent bulk over the shoulders and on the front chest area can reduce downward visibility and become a snagging hazard when attempting aircraft escape.

Similar disadvantages arise in other situations where it is desired to protect a wearer from drowning—for example personnel on board a ship or oil rig who might fall into, or have to evacuate into, the sea-where a separate protection garment and lifejacket create undesirable bulk.

### SUMMARY OF THE INVENTION

According to a first aspect of the present invention there is provided a personal protection garment configured to cover at least a part of a wearer's body in use, wherein the protection garment includes an inflatable chamber configured to provide buoyancy to support the wearer's body on water when inflated to save the wearer from drowning.

The protection garment may be a garment worn by an aircrew member and having a purpose of protecting the aircrew member during normal fight. Conventionally, a lifejacket is worn over a protection garment to provide buoyancy to support the aircrew member's body on water. The protection garment may be a garment worn in other marine applications when protection from drowning is desirable—such as on board a ship or oil rig.

The claimed protection garment may render a conventional lifejacket unnecessary, as the claimed protection garment itself provides buoyancy. Providing buoyancy by an inflatable chamber of the protection garment, rather than by a lifejacket, reduces the number of items the aircrew member (or other personnel) must wear. This reduces bulk, snagging hazards and the time taken for the aircrew member to get ready for flight.

The garment may have protective qualities for the wearer during normal use (that is, when not in water)—such as being fire—retardant or water-resistant. The garment may be configured to protect an aircrew member from fire, high G-acceleration and/or effects of altitude. The garment may be a flight vest or a flight suit, or perform the functions conventionally performed by a flight vest or a flight suit.

The garment may extend at least over the wearer's chest and back, and behind their neck. The coverage of the wearer's body by the garment may correspond to that of a conventional flight vest or suit.

In an embodiment of the invention the inflatable chamber functions as a lifejacket or life preserver unit. The buoyancy required to save the wearer from drowning can be provided by the protection garment itself (by the inflatable chamber thereof). A conventional lifejacket/life preserver, which is not a garment or part of a garment, unit can therefore be dispensed with.

The garment may include triggering means for automatically triggering inflation of the inflatable chamber on contact with water—e.g. a hydrostatic triggering mechanism. Additionally, or alternatively, the inflation of the inflatable chamber may be triggerable manually—e.g. by the aircrew member operating a lever.

In an embodiment of the invention the inflatable chamber extends over the wearer's chest and behind their neck. Such an arrangement provides buoyancy at desired locations to prevent the wearer from drowning. The inflatable chamber, when uninflated, covers only a portion of the area of the protection garment—e.g. the inflatable chamber does not cover the back of the wearer, which is covered by the garment.

The inflatable chamber may be located beneath an outer layer of the garment when deflated, wherein the outer layer includes a line of weakness that opens due to pressure applied by partial inflation of the inflatable chamber to allow full inflation of the inflatable chamber outside the outer surface of the garment. The line of weakness may be formed by a releasable coupling, which may be a burst-open zipper.

The inflatable chamber may be located between the outer and an inner layer of the garment when deflated. The inner layer is preferably adjacent to the wearer's torso.

The outer and inner layers may be substantially inelastic, thereby forming a substantially inelastic pocket for the inflatable chamber. The inelasticity of the pocket causes pressure from inflation of the inflatable chamber to be applied to the releasable coupling, rather than expanding the pocket.

The inflatable chamber may be an inner chamber layer and an outer chamber layer, wherein the inner chamber layer is separate from the outer chamber layer. The configuration of the inflatable chamber as described and claimed may provide a strong and low-bulk inflatable chamber. This is highly advantageous as the garment may have low bulk despite the inclusion of the inflatable chamber. This may increase comfort and safety for the wearer.

According to a second aspect of the present invention there is provided a method of protecting a person from drowning, the method including providing the person with a protection garment configured to cover at least a part of the person's body and to protect the person during normal use, wherein the protection garment includes an inflatable chamber configured to provide buoyancy to support the person's body on water when inflated to prevent the person from drowning, and wherein the method includes inflating the inflatable chamber on contact with the water, or when contact with water is expected, so that the buoyancy protects the person from drowning.

The protection provided by the garment in normal use may be protection that is not related to immersion in water—so as protection from fire or cold.

In the method the protection garment may be as defined above.

According to an embodiment of the invention, it is proposed is to position a life preserver bladder inside the protective garment (e.g. flight jacket/waistcoat) with break-out zippers or the like, that enable inflation of the life preserver bladder, fitted directly to the front of the garment. The life preserver bladder breaks open the zipper due to the pressure exerted by inflation of the bladder. The bladder then passes through the hole made by the zipper opening up.

This embodiment has major advantages to the cosmetic appearance of the ensemble. Instead of a life preserver being fitted over a protection garment (as in a known arrangement), a protection garment is fitted with a life preserver that is not visible when uninflated. The embodiment also removes the bulk away from the top of the wearer's shoulders, the front chest and behind the neck eliminating restrictions to head mobility and helmet interaction. When used with new lighter weight (micro) life preserver designs and a Remote Inflation System (e.g. as described in the applicant's patent GB2573474), the presence of the uninflated life preserver may be practically imperceptible to the wearer.

Due to the reduced packed size, items such as remote antennas, lights, etc., that can normally be fitted to the life preserver bladder, may need to be moved and alternative solutions introduced.

Embodiments of the present invention address one of the biggest issues identified with current life preserver designs: bulk, and restrictions to head mobility and snagging potential.

Embodiments of the present invention may be used in marine and special forces applications. The proactive garment may be a flight suit but could be a garment providing protection in another context.

Because the inflatable chamber is built-in to the garment, the wearer will always be protected from drowning when they wear the garment. In contrast, if a separate garment and lifejacket are used, the lifejacket may be forgotten or deliberately not worn.

All of the features described herein may be combined with any of the above aspects, in any combination.

### BRIEF DESCRIPTION OF THE DRAWINGS

For a better understanding of the present invention embodiments will now be described by way of example, with reference to the accompanying drawings, in which:

FIG. 1 shows a front elevational view of a known flight ensemble comprising a protective flight garment over which a lifejacket is worn;

FIG. 2 shows a left side view of the protective flight garment and lifejacket of FIG. 1 (other side corresponds);

FIG. 3 shows a rear elevational view of the protective flight garment and lifejacket of FIG. 1;

FIG. 4 shows a cross-section taken along line A-A of FIG. 1;

FIG. 5 shows a front elevational view of the protective flight garment and lifejacket of FIG. 1 after the lifejacket is inflated;

FIG. 6 shows a left side view of the protective flight garment and lifejacket of FIG. 1 after the lifejacket is inflated (other side corresponds);

FIG. 7 shows a cross-section taken along line A-A of FIG. 5;

FIG. 8 shows a front elevational view of protective flight garment according to an embodiment of the invention;

FIG. 9 shows a left side view of the protective flight garment of FIG. 8 (other side corresponds);

FIG. 10 shows a rear elevational view of the protective flight garment of FIG. 8;

FIG. 11 shows a cross-section taken along line A-A of FIGS. 8 and 9, including a partially enlarged view, as indicated by the arrow “A”;

FIG. 12 shows a front elevational view of the protective flight garment of FIG. 8 after its inflatable chamber is inflated;

FIG. 13 shows a left side view of the protective flight garment of FIG. 8 after its inflatable chamber is inflated is inflated (other side corresponds);

FIG. 14 shows a cross-section taken along line A-A of FIGS. 12 and 13;

FIG. 15A shows a cross-sectional view of an inflatable chamber according to an embodiment of the invention;

FIG. 15B shows an enlarged detailed view of the layers of the inflatable chamber of FIG. 15A; and

FIG. 15C shows an enlarged view of the inflatable chamber of FIG. 15A where the upper and lower layers are connected.

In the drawings like elements are generally designated with the same reference sign.

### DETAILED DESCRIPTION OF EMBODIMENTS OF THE INVENTION

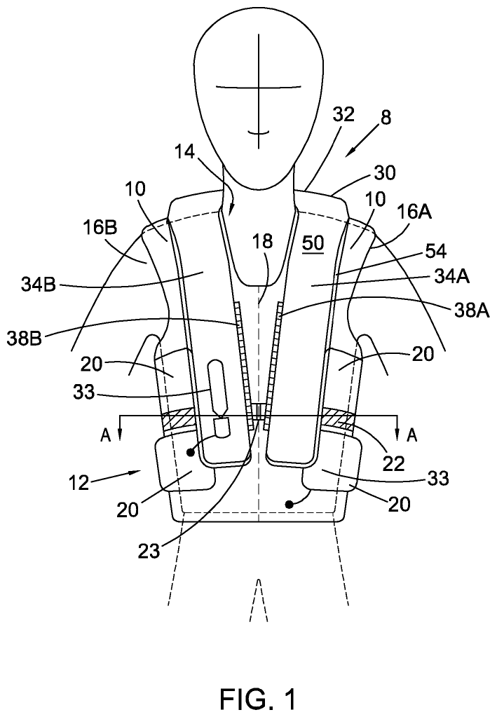

Referring first to FIG. 1, 2 or 3, a known aircrew ensemble 8 includes a protective flight garment 10 that in this example is a flight vest (but could instead be a jacket or full body suit) that is worn by an aircrew member (which could be any person on board an aircraft). The flight garment 10 may be made from an inherently fireproof fabric such as NOMEX®. The flight garment 10 has a waist portion 12, a neck opening 14, and left and right arm holes 16A and 16B, respectively. The flight garment 10 also has a front opening 18 closed by, for example, a conventional zipper.

The flight garment 10 carries equipment pockets 20. The flight garment 10 also carries a waist belt 22. The waist belt 22 may be secured at the front of the torso by a buckle 23 or any other suitable coupling.

As shown in FIG. 1, 2 or 3, the aircrew ensemble 8 includes a lifejacket 30 that is worn over, and may be attached to, the flight garment 10. The lifejacket 30, in the example shown, is generally U-shaped and has a central portion 32 that passes around the back of the wearer's neck and two arms 34A and 34B extending from opposite left- and right-hand sides of the central portion 32 configured to lie over opposite sides in front of the wearer's torso 31. Other shapes and configurations of lifejacket are possible.

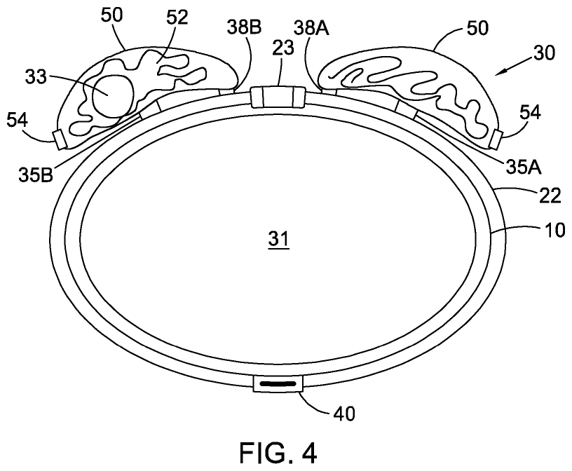

The lifejacket 30 is fitted with one or more inflation systems 33, such as a compressed gas cylinder for inflating a bladder (as shown at 52 in FIG. 4) within the lifejacket 30.

The lifejacket 30 is typically attached to the flight garment 10 in two or three or more places.

In the example shown, at the front torso the lifejacket 30 is attached to the flight garment 10 by a pair of zippers 38A and 38B. This attachment is important in aircrew use as they may experience “wind blast” if ejecting from an aircraft at speed which could detach the lifejacket 30 if it is not securely attached to the flight garment 10.

A left-hand side zipper 38A has a first row of teeth extending longitudinally along the inner side of the left arm 34A of the lifejacket 30 and a corresponding second row of teeth extending longitudinally along the front of the flight garment 10 generally parallel and spaced to the left of the opening 18 of the flight garment 10. The left arm 34A of the lifejacket 30 is attached to the flight garment 10 by drawing a slider (not shown) of the zipper 38A upwards, which draws the first and second rows of teeth together in the conventional manner of operation of a zipper.

Similarly, a right-hand side zipper 38B has a third row of teeth extending longitudinally along the inner side of the right arm 34B of the lifejacket 30 and a corresponding fourth row of teeth extending longitudinally along the front of the flight garment 10 generally parallel and spaced to the right of the opening 18 of the flight garment 10. The right arm 34B of the lifejacket 30 is attached to the flight garment 10 by drawing a slider (not shown) of the zipper 38B upwards, which draws the third and fourth rows of teeth together in the conventional manner of operation of a zipper.

Alternative attachment arrangements to zippers may be used to attach the lifejacket 30 at the front torso to the flight garment 10, such as by buckles or the like.

In the example shown, the arms 34A and 34B of the lifejacket 30 are attached to the waist belt 22 at points 35A and 35B (see FIG. 4) at the left- and right-hand sides of the wearer's torso, respectively. This attachment may be by the waist belt 22 passing through a respective loop (not shown) attached to the underside of the left arm 34A and to the underside of the right arm 34B the lifejacket 30. These form strong anchoring points when the lifejacket 30 is inflated.

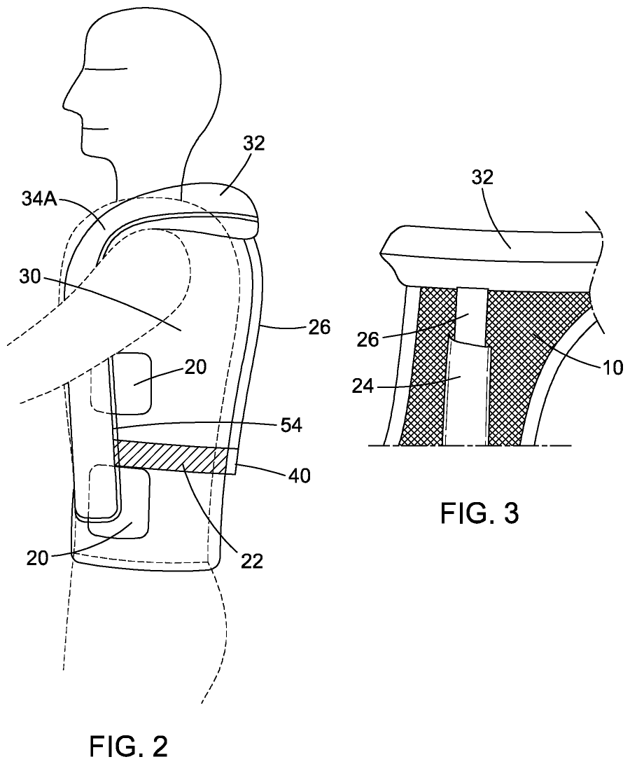

A back strap 26 is attached at its lower end to the waist belt 22 (e.g. by lifejacket loop 40—see FIGS. 2 and 4) at the centre of the rear torso and is attached to the lifejacket 30 at its upper end at the central portion 32 at the back of the neck. This may prevent the lifejacket 30 riding up over the wearer's head when inflated. The back strap 26 may be threaded through the channel 24 of the flight garment 10 to further locate the back strap 26, as shown in FIG. 3.

As shown in FIG. 4, the lifejacket 30 has a cover 50 which protects an inflatable bladder 52, which is packed inside the cover 50, from damage. The inflation system 33 can be contained within the cover 50 (as shown in FIGS. 1 and 4) or can be remote from the cover 50 and connected by a tube to the bladder 52 (a Remote Inflation System).

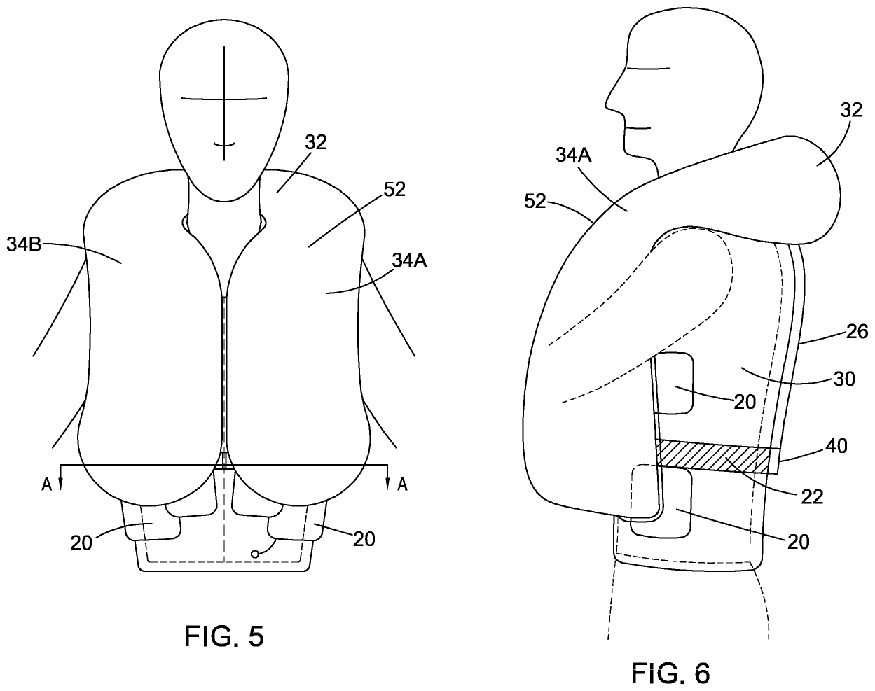

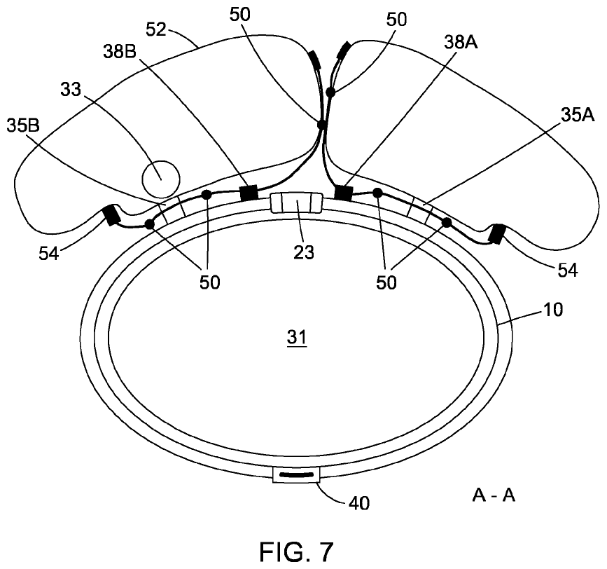

When the lifejacket inflation system 33 is activated, the cover 50 will automatically open either by way of an automatically releasable closure 54, such as a “burst open” zipper, Velcro® or press studs etc. When the lifejacket inflation system 33 is activated (either manually or automatically), the inflating bladder 52 acts on the automatically releasable closure 54 to open it. FIGS. 5, 6 and 7 show the bladder 52 when fully inflated, after the automatically releasable closure 54 has opened.

According to an embodiment of the invention, rather than having an aircrew ensemble that includes a lifejacket that is worn over a protective flight garment, the protective flight garment itself carries a buoyancy-providing inflatable bladder and no separate lifejacket is required. That is, the inflatable bladder is integrated into the protective flight garment that is worn on the body of the wearer.

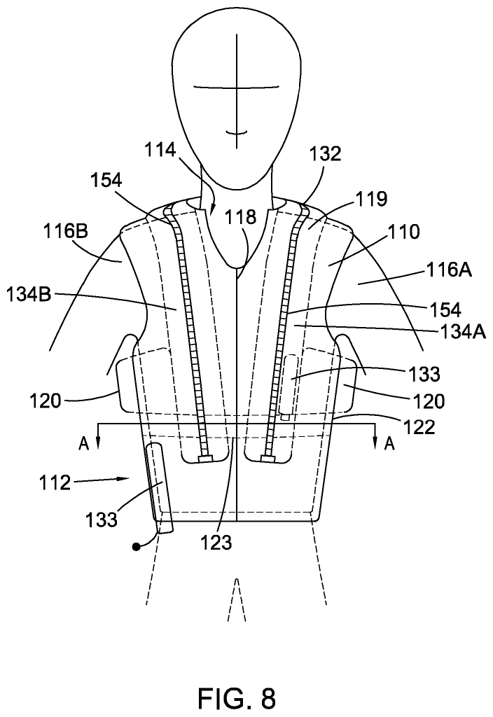

Referring first to FIGS. 8, 9 and 10, a novel protective flight garment 110 that in this example is a flight vest (but could instead be a jacket or full body suit) is provided. The flight garment 110 may be made from an inherently fireproof fabric such as NOMEX®. The protective flight garment 110 may include special equipment (Aircrew Life Support Equipment—ALSE) that protects the wearer against the effects of high G-acceleration or altitude and other potentially damaging factors.

The flight garment 110 has a waist portion 112, a neck opening 114, and left and right arm holes 116A and 116B, respectively. The flight garment 110 also has a front opening 118 closed by, for example, a conventional zipper. When the front opening 118 is closed, the flight garment 110 is securely attached to the body of the wearer.

The flight garment 110 carries equipment pockets 120. The flight garment 110 also carries a waist belt 122. The waist belt 122 may be secured at the front of the torso by a buckle 123 or any other suitable coupling.

The flight garment 110 in the embodiment extends at least over the aircrew member's chest and back, and behind their neck.

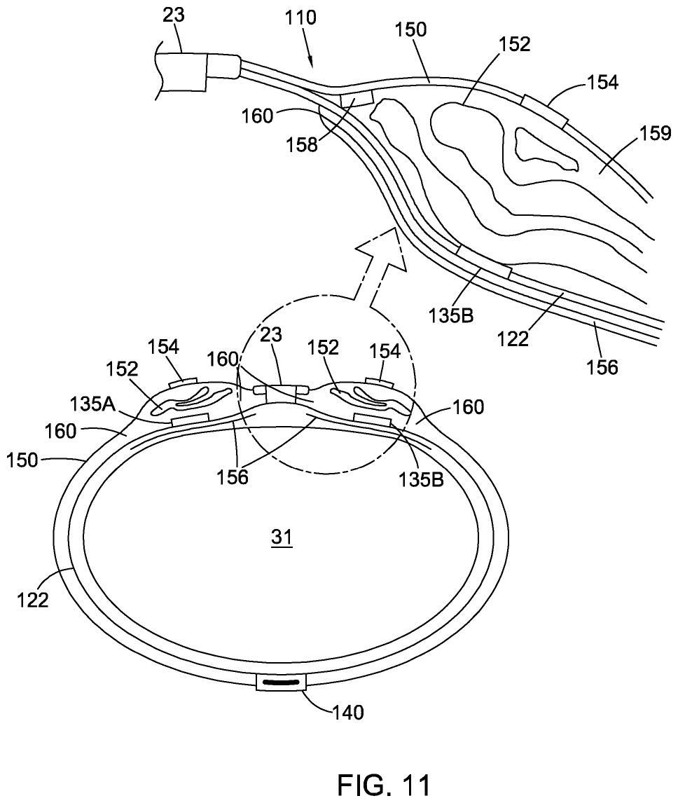

As shown in FIGS. 8, 9 and 10, the flight garment 110 has a region 119 in which a deflated inflatable bladder-or inflatable chamber—152 (see FIG. 11) is accommodated. The region 119, in the example shown, is generally U-shaped and has a central portion 132 that passes around the back of the wearer's neck and two arms 134A and 134B extending from opposite left- and right-hand sides of the central portion 132 configured to lie over opposite sides in front of the wearer's torso 31.

The deflated bladder 152 has a similar shape and size to the region 119, so that deflated bladder 152 is also generally U-shaped and has a central portion that passes around the back of the wearer's neck and with two arms extending from opposite left- and right-hand sides of the central portion configured to lie over opposite sides in front of the wearer's torso 31. The deflated bladder 152 may be folded to fit in the region 119.

Other shapes and configurations of the region 119 and the bladder 152 are possible.

The region 119 is fitted with one or more inflation systems 133, such as a compressed gas cylinder for inflating the bladder 152 within the region 119. The inflation system 133 may be automatically triggered on contact with water and/or may be manually triggered by the aircrew member.

In the example shown, the arms 134A and 134B of the bladder 152 are attached to the waist belt 122 at strong attachment points 135A and 135B (see FIG. 11) at the left- and right-hand sides of the wearer's torso, respectively. This attachment may be by the waist belt 122 passing through a respective loop (not shown) attached to the underside of the left arm of the bladder and to the underside of the right arm of the bladder. The attachment points 135A and 135B form strong anchoring points when the bladder 152 is inflated. The waist belt 122 may be integrated into the garment 110.

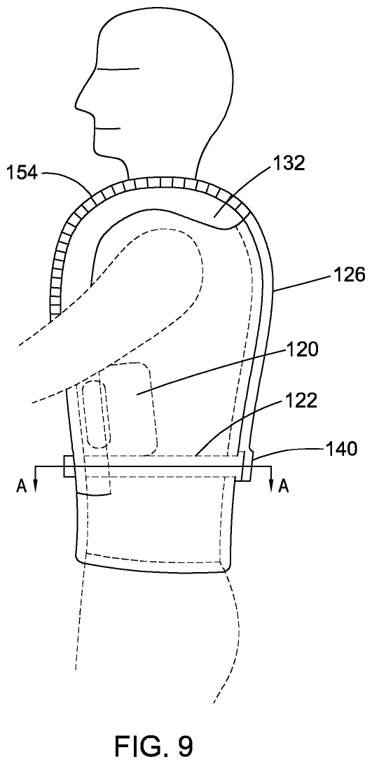

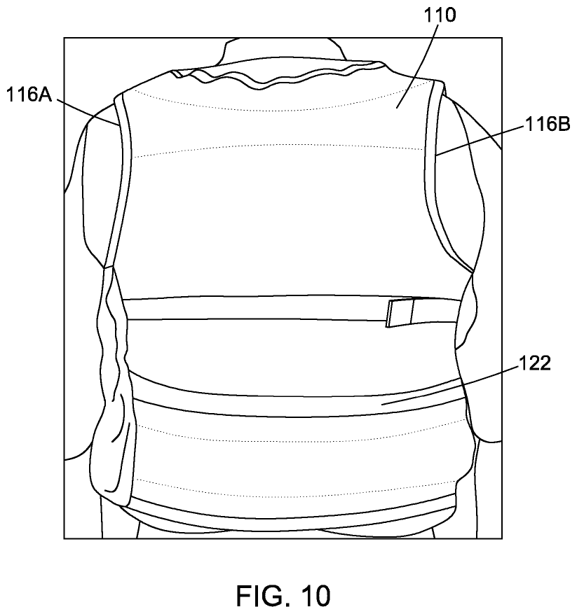

A back strap 126 may be attached at its lower end to the waist belt 122 (e.g. by loop 140—see FIGS. 9 and 11) at the centre of the rear torso and is attached to the bladder 152 at its upper end at the central portion 132 at the back of the neck. This may prevent the bladder 152 riding up over the wearer's head when inflated. The back strap 126 may be threaded through the channel (not shown) of the flight garment 110 to further locate the back strap 126. The back strap 126 may be integrated into the garment 110 or may be omitted (as shown in FIG. 10).

As shown in FIG. 11, the bladder 152 is packed deflated inside the outer surface (exterior or front layer) 150 of the flight garment 110, to protect the bladder 152 from damage. The inflation system 133 can be contained beneath the outer surface 150 or can be remote from the outer surface 150 and connected by a tube to the bladder 152 (e.g. by a Remote Inflation System, e.g. as described in the applicant's patent GB2573474).

An internal cover (interior or rear layer) 156 can be fitted to protect the bladder 152 inside the garment. The internal cover 156 lies between the bladder 152 and the torso 31 of the wearer. The internal cover 156 is preferably substantially inelastic. The internal cover 156 may be formed from an inelastic woven material. The generally inelastic nature of the internal cover 156 means that it does not expand significantly when the bladder 152 is inflated. As a consequence, inflation of the bladder 152 applies pressure to the automatically releasable closure 154, rather than expanding the internal cover 156.

Similarly, the outer surface (exterior surface) 150 of the garment 110 may also be formed of a substantially inelastic material, such as an inelastic woven material. The generally inelastic nature of the outer surface 150 means that it does not expand significantly when the bladder 152 is inflated. As a consequence, inflation of the bladder 152 applies pressure to the automatically releasable closure 154, rather than expanding the outer surface 150.

Together, the internal cover 156 and the outer surface (exterior surface) 150 of the flight garment 110 form a pocket 159 within which the deflated bladder 152 is contained. The area where both the internal cover 156 and the outer surface (exterior surface) 150 are present corresponds to the region 119 in which a deflated inflatable bladder 152 is accommodated.

The internal cover 156 has a similar shape and size to the region 119, so that the internal cover 156 is also generally U-shaped and has a central portion that passes around the back of the wearer's neck and with two arms extending from opposite left- and right-hand sides of the central portion configured to lie over opposite sides in front of the wearer's torso 31.

Openings 160 may be provided in the internal cover 156 at locations in each of its arms that correspond to the position of the waist belt 122. The waist belt 122 may pass through the openings 160 so that the strong attachment points 135A and 135B, where the arms and of the bladder 152 are attached to the waist belt 122, are inside the pocket 159. A total of four openings 160 may be provided, two in each arm.

The outer surface 150 of the flight garment 110 is provided with an automatically releasable closure 154 in the region 119, e.g. in the centre of the region 119. The automatically releasable closure 154 may be a “burst open” zipper, Velcro® or press studs etc. The automatically releasable closure 154 may be a slide fastener as described in the applicant's patent publication GB2588110. The automatically releasable closure 154 extends along the two arms 134A and 134B and the central portion 136, behind the wearer's neck.

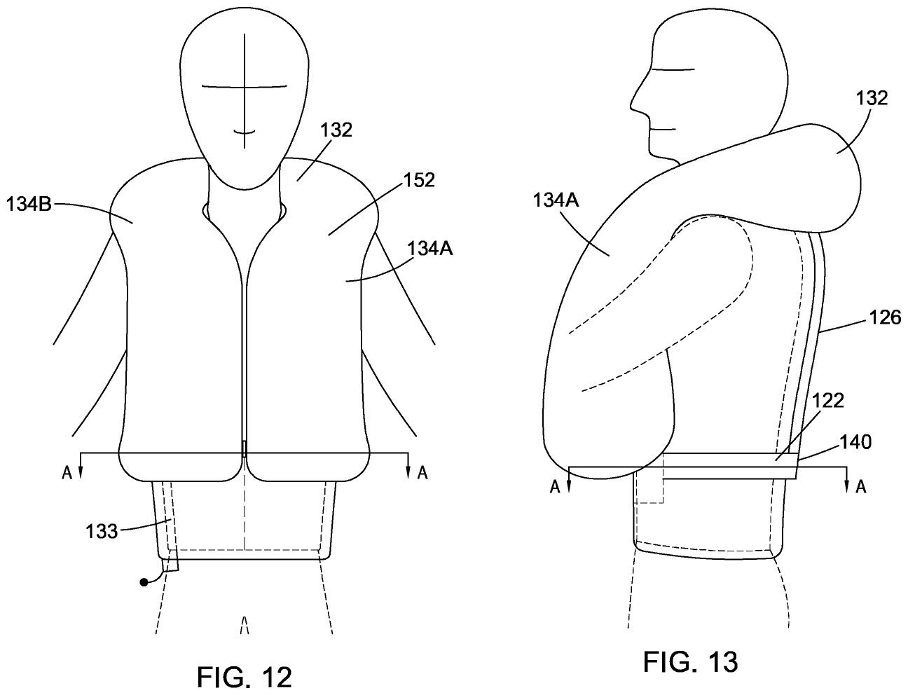

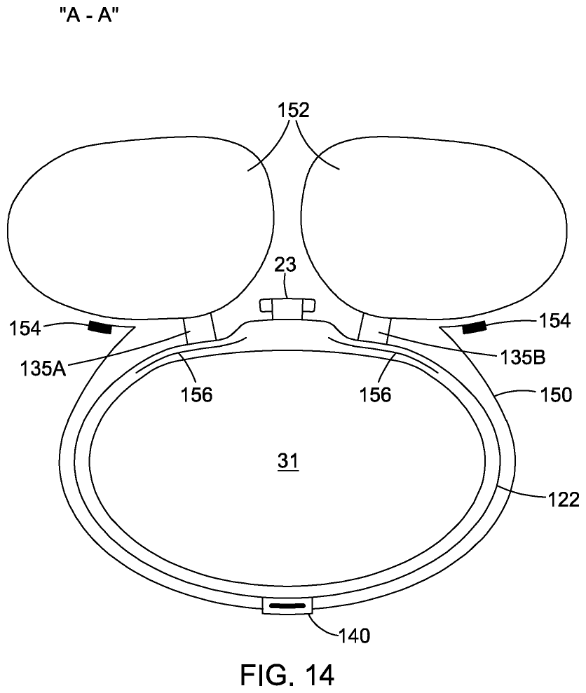

When the inflation system 133 is activated, the outer surface 150 will automatically open by way of the automatically releasable closure 154. When the inflation system 133 is activated (either manually or automatically), the inflating bladder 152 acts on the automatically releasable closure 154 to open it. The pressure generated by inflation of the bladder 152 causes the automatically releasable closure 154 to open. When the automatically releasable closure 154 opens, the bladder 152 passes through the opening as further inflation occurs. FIGS. 12, 13 and 14 show the bladder 152 when fully inflated, after the releasable closure 154 has opened.

FIGS. 12, 13 and 14 depict the bladder 152 after it has moved from the interior of the garment 110 (as shown in FIGS. 8 to 11) to the exterior of the garment 110 as it inflates. The inflated bladder is positioned over the wearer's chest and behind the wearer's neck and provides buoyancy, thereby preventing drowning in the event that the aircrew member makes an emergency landing in water.

The internal cover 156 or the outer surface 150 may be opened by a releasable closure 158 (e.g. formed by press studs, a conventional zipper or Velcro®) to allow the bladder 152 to be removed from the garment 110 for maintenance or repair. Unlike the automatically releasable closure 154, the releasable closure 158 is not configured to open automatically when the bladder 152 is inflated.

In this embodiment, instead of using a conventional single layer of material that consists of a textile supporting sheet (for example nylon or polyester) coated or laminated on the inside with a sheet of flexible air impermeable polymer such as neoprene or polyurethane, the two separate layers are provided (i.e. a textile outer layer and the separate inner polymer layer) to form the bladder 152.

The use of two separate layers to make the bladder 152 may result in a bladder construction that is lighter, more compact when packed and stronger.

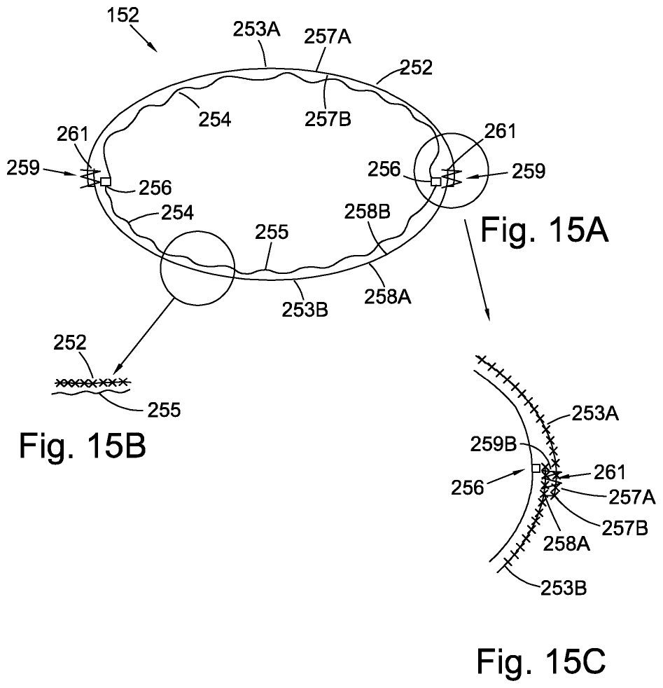

As shown in FIGS. 15A-C, a textile outer layer 252 (for example nylon or polyester) of the bladder 152 may be formed of two sheets of material that are stitched together. An upper sheet of material 253A has an outer surface 257A and an inner surface 257B. The lower sheet of material 253B has an outer surface 258A and an inner surface 258B. The sheets 253A and 253B are connected at an edge region 259 of each of the sheets so that the distal inner surface of one of the sheets overlaps the distal outer surface of the other one of the sheets, the distal surfaces being stitched together, as indicated at 261. In the arrangement shown the distal inner surface 257B of the upper layer 257A is positioned to face the distal portion of the outer surface 258A of the lower layer 253B, these layers being held in contact by the stitching 261.

An inner layer 255 of the bladder 152 is formed by two sheets 254 of flexible air impermeable material. The two sheets are joined by a weld 256.

In this embodiment the outer textile layer 252 can be stitched (in sheer) around its edge and this creates a much stronger seam than the welding. The inner layer of the bladder 152 is made to be oversize or made from a polymer that can stretch and so the welded edge 256 never comes under tension, as shown in FIGS. 15A-C. Although the inner layer 255 of the bladder 152 may be of generally the same shape as the outer textile layer 252, the inner layer 255 of the bladder 152 may be of generally larger size. The inner layer 255 of the bladder 152 may be made of a sufficiently large size so that, when inflated within the outer textile layer 252, the inner layer 255 of the bladder 152 fills the internal volume of the outer textile layer 252 without any stretching of the inner layer 255 of the bladder 152 occurring, and the tension is taken up by the outer textile layer 252. If the inner layer of the bladder 152 is made oversized, the inner layer 255 of the bladder 152 may be made of an inextensible and/or inelastic material. It is advantageous for the tension to be taken up by the outer textile layer 252, as it is stronger than the inner layer of the bladder 152.

Preferably, the outer textile layer 252 is made from a lightweight “ripstop” material and is coated with a lubricant such as silicon. This produces an extremely strong material with high tear strength, and also, because the surface has a very low surface friction, the inner polymer layer 255 will slide easily over it which results in a very compact lifejacket.

Ripstop fabrics are woven fabrics, e.g. made of nylon, using a special reinforcing technique that makes them resistant to tearing and weaving, ripping. During relatively thick reinforcement threads are interwoven at regular intervals in a crosshatch pattern. The intervals are typically 5 to 8 mm. Thin and lightweight ripstop fabrics have a 3-dimensional structure due to the thicker threads being interwoven in thinner cloth.

In the above embodiment that LPU bladder is mounted on the interior face of a jacket or vest, suit etc. (i.e. a garment), but on activation of the inflation moves from the interior to the exterior of the garment via an automatically opening zipper or Velcro or press studs etc. as a result of the bladder being pressurised.

The protection garment may be a garment worn by an aircrew member and having a purpose of protecting the aircrew member during normal fight—as described in the embodiment above. The protection garment may alternatively be a garment worn in other applications when protection from drowning is desirable—such as on board a ship or oil rig.

The above embodiments are described by way of example. Many variations are possible without departing from the invention.

1. A personal protection garment configured to cover at least a part of a wearer's body in use, wherein the protection garment includes an inflatable chamber configured to provide buoyancy to support the wearer's body on water when inflated to save the wearer from drowning.

2. The garment of claim 1, wherein the garment is configured to protect the wearer from at least one of fire, high G-acceleration and effects of altitude.

3. The garment of claim 1, wherein the inflatable chamber functions as a lifejacket or life preserver unit.

4. The garment of claim 1, further including triggering means for automatically triggering inflation of the inflatable chamber on contact with water.

5. The garment of claim 1, wherein the inflatable chamber extends over the wearer's chest and behind their neck.

6. The garment of claim 1, wherein the garment extends at least over the wearer's chest and back, and behind their neck.

7. The garment of claim 1, wherein the garment is a flight vest or a flight suit.

8. The garment of claim 1, wherein the inflatable chamber is an inflatable bladder.

9. The garment of claim 8, wherein the inflatable bladder is located under an outer garment layer of the garment when deflated, wherein the outer garment layer includes a line of weakness that opens due to pressure applied by partial inflation of the inflatable bladder to allow full inflation of the inflatable bladder outside the outer garment layer of the garment.

10. The garment of claim 9, wherein the outer garment layer is substantially inelastic.

11. The garment of claim 9, wherein the inflatable bladder is located between the outer garment layer and an inner garment layer of the garment when deflated.

12. The garment of claim 11, wherein the inner garment layer is configured to lie adjacent to the wearer's torso.

13. The garment of claim 11, wherein the inner garment layer is substantially inelastic.

14. The garment of claim 9, wherein the line of weakness is formed by a releasable coupling.

15. The garment of claim 8, wherein the inflatable bladder includes an inner bladder layer and an outer bladder layer, wherein the inner bladder layer is separate from the outer bladder layer.

16. The garment of claim 15, wherein the outer bladder layer comprises first and second sheets of material, wherein the first sheet of material has an outer surface and an inner surface, the second sheet of material has an outer surface and an inner surface, and the first sheet of material and the second sheet of material are connected at an edge region of each of the sheets so that a distal portion of the inner surface of one of the sheets overlaps a distal portion of the outer surface of the other one of the sheets, the distal surfaces being stitched together.

17. The garment of claim 15, further including a low friction material between the inner bladder layer and the outer bladder layer.

18. The garment of claim 15, wherein the outer bladder layer is substantially inelastic.

19. A method of protecting a person from drowning, the method including providing the person with a protection garment configured to cover at least a part of the person's body to protect the person during normal use, wherein the protection garment includes an inflatable chamber configured to provide buoyancy to support the person's body on water when inflated to prevent the person from drowning, and the method includes inflating the inflatable chamber on contact with the water, or when contact with water is expected, so that the buoyancy protects the person from drowning.

20. The method of claim 19, wherein the inflatable bladder is located under an outer garment layer of the garment when deflated, wherein the outer garment layer includes a line of weakness that opens due to pressure applied by partial inflation of the inflatable bladder to allow full inflation of the inflatable bladder outside the outer garment layer of the garment.
